(19) United States
(12) Patent Application Publication
(10) Pub. No.: US 2025/0019483 A1
(43) Pub. Date: Jan. 16, 2025

(54) PREPARATION OF POLYISOCYANATES CONTAINING IMINOOXADIAZINEDIONE GROUPS AND THEIR USE

(71) Applicant: BASF SE, Ludwigshafen am Rhein (DE)

(72) Inventors: Frederic LUCAS, Ludwigshafen am Rhein (DE); Nico VELING, Ludwigshafen am Rhein (DE); Kerstin HEINEN, Ludwigshafen am Rhein (DE); Harald SCHAEFER, Ludwigshafen am Rhein (DE); Jens SCHEIDEL, Ludwigshafen am Rhein (DE); Thomas GENGER, Ludwigshafen am Rhein (DE)

(21) Appl. No.: 18/709,569

(22) PCT Filed: Nov. 11, 2022
(86) PCT No.: PCT/EP2022/081568

§ 371 Date: May 13, 2024

(30) Foreign Application Priority Data
Nov. 16, 2021 (EP) 21208542.7

(51) Int. Cl. C08G 18/16; C08G 18/02

(52) U.S. Cl. CPC C08G 18/168; C08G 18/022

(57) ABSTRACT

A process for the preparation of polyisocyanates containing iminooxadiazinedione groups, comprising reacting at least one (cyclo)aliphatic diisocyanate in the presence of at least one oligomerization catalyst, and when the reaction has reached a predeterminable degree of conversion, based on the (cyclo)aliphatic diisocyanates, stopping the reaction by addition of at least one catalyst poison for the oligomerization catalyst, wherein the oligomerization catalyst is a salt containing a fluoride or poly(hydrogen)fluoride [F⁻×(HF)ₘ] as anion and the catalyst poison is a solution containing at least one alcohol comprising at least 6 carbon atoms as solvent and wherein m is a number between 0.01 and 20.

The present invention relates to a novel process for preparing polyisocyanates containing iminooxadiazinedione groups by a partial trimerization of (cyclo)aliphatic diisocyanate in the presence of at least one oligomerization catalyst and when the reaction has reached a predeterminable degree of conversion, the reaction is stopped by addition of at least one catalyst poison, and to the use of the thus obtainable polyisocyanates containing iminooxadiazinedione groups as a polyisocyanate component in polyurethane coatings.

Processes for partially or fully trimerizing (cyclo)aliphatic polyisocyanates for preparing polyisocyanates containing iminooxadiazinedione groups or cellular or compact polyurethanes having isocyanurate groups are known and are described in numerous literature publications.

These state-of-the-art processes are summarized in H. J. Laas et al, J. Prakt. Chem. 1994, 336, 185 ff.

EP-A 962455, 962454, 896009, 798299, 447074, 379914, 339396, 315692, 295926 and 235388 disclose processes which lead to products with a high proportion of iminooxadiazinedione groups (asymmetric isocyanate trimers).

Suitable catalysts are, for example, fluoride or poly(hydrogen)fluoride [F⁻×(HF)ₘ], preferably with quaternary phosphonium cations as counterions, wherein m is a number between 0.001 till 20, preferably 0.5 till 5, very preferably 1.

EP2976373 discloses a catalyst kit comprising a trimerization catalyst for the asymmetric trimerization of polyisocyanates and a catalyst poison for the trimerization catalyst. Possible catalyst poisons, i.e., stoppers, are quite generally anhydrous acids having a pKa value below 3.2.

However, disadvantages of these prior art processes are that the reactivity of the catalyst kit, containing catalyst and catalyst poison, is low, caused, among other things, by partially decom-position of the catalyst kit.

It is an object of the present invention to provide a process for the preparation of polyisocyanates containing a high content of iminooxadiazinedione groups which is characterized by a higher reactivity. Catalyst and catalyst poison should be employable over a wide temperature range, should have a good solubility in the reaction mixture and should have less tendency to decompose. The solvent of the catalyst and specifically of the stopper solution should have no negative impact on the process.

This object is achieved by a process for preparing polyisocyanates containing iminooxadiazinedione groups by at least reacting at least one (cyclo)aliphatic diisocyanate in the presence of at least one oligomerization catalyst, and when the reaction has reached a predeterminable degree of conversion, based on the (cyclo)aliphatic diisocyanates, stopping the reaction by addition of at least one catalyst poison for the oligomerization catalyst, wherein the oligomerization catalyst is a salt containing a fluoride or poly(hydrogen)fluoride [F⁻×(HF)ₘ] as anion and the catalyst poison is a solution containing at least one alcohol comprising at least 6 carbon atoms as solvent.

A further object of the present invention relates to the use of the thus obtainable polyisocyanates containing iminooxadiazinedione groups as a polyisocyanate component in polyurethane coatings.

Oligomerization catalysts are salts containing a poly(hydrogen)fluoride [F⁻×(HF)ₘ] as anion, wherein m is a number between 0.01 and 20, preferably between 1 and 20, more preferably between 1 and 5, even more preferably between 0.8 and 1.2, and most preferably 1.

Suitable cations may in principle be any species known to be catalytically active with respect to isocyanates. These cations may ensure good solubility in the isocyanate medium. Preference is being given to tetraalkylammonium, tetraalkylphosphonium, guanidinium, sulfonium, imidazolium, benzotriazolium and pyridinium. Especially preferred are cations according to formula (I)

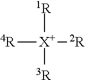

wherein
X is nitrogen or phosphorus and
R¹, R², R³ and R⁴ may each independently be the same or different and are each a straight-chain or branched optionally substituted, preferably not substituted C₁- to C₂₀-alkyl group, an optionally substituted, preferably not substituted C₅- to C₁₂-cycloalkyl group, an optionally substituted, preferably not substituted C₇- to C₁₀-aralkyl group, or an optionally substituted, preferably not substituted C₆-C₁₂-aryl group, or
two or more of the R¹ to R⁴ radicals together form a 4-, 5- or 6-membered alkylene chain or, together with a nitrogen atom, form a 5- or 6-membered ring which may also contain an additional nitrogen or oxygen atom as a bridge member, or together form a multimembered, preferably six-membered, polycyclic system, preferably bicyclic system, which may also contain one or more additional nitrogen atoms, oxygen atoms or oxygen and nitrogen atoms as bridge members.

In these compounds,
a straight-chain or branched, not substituted C₁- to C₂₀-alkyl group is, for example, methyl, ethyl, propyl, isopropyl, n-butyl, isobutyl, sec-butyl, tert-butyl, pentyl, hexyl, heptyl, octyl, 2-ethylhexyl, 2,4,4-trimethylpentyl, nonyl, dodecyl, eicosyl, decyl, 1,1-dimethylpropyl, 1,1-dimethylbutyl or 1,1,3,3-tetramethylbutyl,
an optionally substituted C₅- to C₁₂-cycloalkyl group is cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, or else a saturated or unsaturated bicyclic system, for example norbornyl or norbornenyl,
an optionally substituted C₇- to C₁₀-aralkyl group is, for example, benzyl, 1-phenylethyl, 2-phenylethyl, α,α-dimethylbenzyl, benzhydryl, p-tolylmethyl, 1-(p-butylphenyl)ethyl, o-, m- or p-chlorobenzyl, 2,4-dichlorobenzyl, o-, m- or p-methoxybenzyl or o-, m- or p-ethoxybenzyl,
an optionally substituted C₆-C₁₂-aryl group is, for example, phenyl, 2-, 3- or 4-methylphenyl, α-naphthyl or β-naphthyl,
an optionally substituted C₁-C₂₀-alkyl optionally interrupted by one or more oxygen and/or sulfur atoms and/or one or more substituted or unsubstituted imino groups or substituted by functional groups, aryl, alkyl, aryloxy, alkyloxy, halogen, heteroatoms and/or heterocycles is, for example, 2-carboxyethyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxy-ethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 1-hydroxy-1,1-dimethylmethyl, 2-hydroxy-2,2-dimethylethyl, 2-phenoxyethyl, 2-phenoxypropyl, 3-phenoxy-propyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl, and
C₆- to C₁₂-aryl optionally interrupted by one or more oxygen atoms and/or sulfur atoms and/or one or more substituted or unsubstituted imino groups or substituted by functional groups, aryl, alkyl, aryloxy, alkyloxy, halogen, heteroatoms and/or heterocycles is, for example tolyl, xylyl, 4-diphenylyl, chlorophenyl, dichlorophenyl, trichlorophenyl, difluorophenyl, methylphenyl, dime-thyl-phenyl, trimethylphenyl, ethylphenyl, diethylphenyl, isopropylphenyl, tert-butylphenyl, do-decyl-phenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitro-phenyl, 4-dimethylaminophenyl, 4-acetylphenyl, methoxyethylphenyl or ethoxymethylphenyl.

Examples of R¹ to R⁴ are in each case independently methyl, ethyl, 2-hydroxyethyl, 2-hydroxypropyl, n-propyl, isopropyl, n-butyl, sec-butyl, tert-butyl, pentyl, hexyl, heptyl, octyl, 2-ethylhexyl, nonyl, decyl, dodecyl, phenyl, α- or β-naphthyl, benzyl, cyclopentyl or cyclohexyl.

When two or more of the R¹ to R⁴ radicals form one or two rings these may be, for example, 1,4-butylene, 1,5-pentylene, 3-oxa-1,5-pentylene, 3-aza-1,5-pentylene, 3-methyl-3-aza-1,5-pentylene, 5-Azonia-spiro[4.4]nonanium, 5-Azonia-spiro[4.5]decanium, 6-Azonia-spiro[5.5]undeca-nium, 6-Azonia-spiro[6.6]dodecanium, 7-Azonia-spiro[7.7]tridecanium, 1,1-Diemthylpyrrolidin-1-ium, 1,1-Diemthylpiperidin-1-ium, 5-Azonia-spiro[4.5]decan-3-ol-ium, 5-Azonia-spiro[4.4]non-3-ol-anium, 1,1-Diemthylpyrrolidin-1-uim-3-ol, or 1,1-Diemthylpiperidin-1-ium-3-ol.

Preferred R¹ to R⁴ radicals are each independently methyl, ethyl, 2-hydroxyethyl, 2-hydroxy-propyl, propyl, isopropyl, n-butyl, tert-butyl, hexyl, octyl, 2-ethylhexyl, nonyl, decyl, dodecyl, phenyl and benzyl, particular preference is given to methyl, ethyl, n-butyl, octyl, decyl, dodecyl, phenyl and benzyl, very particular preference is given to methyl, ethyl, n-butyl, octyl, decyl, dodecyl and in particular methyl, n-butyl, octyl, decyl and dodecyl.

In one embodiment of the present invention all radicals R¹ to R⁴ are hydrocarbons without any atoms other than carbon or hydrogen.

Examples of such ammonium cations are tetraoctylammonium, tetramethylammonium, tetraethylammonium, tetra-n-butylammonium, trimethylbenzylammonium, triethylbenzylammonium, tri-n-butylbenzylammonium, trimethylethylammonium, trimethyloctylammonium, trimethyldec-ylammonium, trimethyldodecylammonium, benzyldimethyloctylammonium, benzyldimethyldecylammonium, benzyldimethyldodecylammonium, tri-n-butylethylammonium, triethylmethyl-ammonium, tri-n-butylmethylammonium, diisopropyldiethylammonium, diisopropylethylme-thylammonium, diisopropylethylbenzylammonium, N,N-dimethylpiperidinium, N,N-dimethylmor-pholinium, N,N-dimethylpiperazinium or N-methyldiazabicyclo[2.2.2]octane.

Preferred alkyl-ammonium ions are tetraoctylammonium, tetramethylammonium, tetraethylammonium and tetra-n-butylammonium, particular preference is given to tetramethylammonium and tetraethylammonium and very particular preference is given to tetra-n-butylammonium.

Further examples of ammonium cations are described in WO2021/122508. Described are cyclic ammonium cations of the formula II

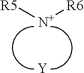

where Y is a linear or branched C2-C20 segment which is substituted by a hydroxyl group in the 2 position to the charge-bearing nitrogen atom and optionally bears further substituents and is optionally interrupted by heteroatoms from the group of oxygen, sulfur, nitrogen and aromatic rings and optionally has further rings, and the N-bonded substituents R5 and R6 are either independently identical or different, substituted or unsubstituted, optionally branched, aliphatic C1-C20 radicals, aromatic C6-C20 radicals or araliphatic C7-C20 radicals or the N-bonded substituents R5 and R6 form a ring segment X with one another for which the same or different definition given above for Y is applicable, with the proviso that X has a hydroxyl group as substituent in the 2 position to the charge-bearing nitrogen atom or does not have a hydroxyl group as substituent in the 2 position to the charge-bearing nitrogen atom.

In a preferred embodiment the sum of carbon atoms in the radicals R¹ to R⁴ is at least 11, particularly preferred at least 13, very particularly preferred at least 15.

In another embodiment of the present invention one radical out of the four radicals R¹ to R⁴ is a substituted C₁-C₂₀-alkyl the other three radicals being hydrocarbons.

Examples of such ammonium cations are 2-hydroxyethyl trimethylammonium, 2-hydroxypropyl trimethylammonium, 2-hydroxyethyl triethylammonium, 2-hydroxypropyl triethylammonium, 2-hydroxyethyl tri-n-butylammonium, 2-hydroxypropyl tri-n-butylammonium, 2-hydroxyethyl dimethyl benzyl ammonium, 2-hydroxypropyl dimethyl benzyl ammonium, N-(2-hydroxyethyl), N-methyl morpholinium, N-(2-hydroxypropyl), N-methyl morpholinium or 3-hydroxy quinuclidine, preferably 2-hydroxyethyl trimethylammonium, 2-hydroxypropyl trimethylammonium, 2-hydroxyethyl dimethyl benzyl ammonium and 3-hydroxy quinuclidine, very preferably 2-hydroxyethyl trimethylammonium and 2-hydroxypropyl trimethylammonium and particularly preferably 2-hydroxypropyl trimethylammonium.

Ammonium ions containing ring systems are, for example, methylated, ethylated or benzylated piperazines, piperidines, morpholines, quinuclidines or triethylenediamines.

However, this embodiment is less preferred than the embodiment with all radicals R¹ to R⁴ being hydrocarbons.

Preferred phosphonium ions are tetramethyl phosphonium, tetrabutyl phosphonium, tetraoctyl phosphonium, and tetradecyl phosphonium, trihexyl(tetradecyl)phosphonium, triisobutyl(methyl)phosphonium, tributyl(tetradecyl)phosphonium, tri-n-butylethylphosphonium, tributyl(octyl)phosphonium, tetra-n-butylphosphonium and mixtures thereof. Specifically, preferred is tetra-n-butyl phosphonium.

The oligomerization catalyst containing a poly(hydrogen)fluoride [F⁻×(HF)ₘ] as anion may for example be a quaternary ammonium fluoride, ammonium difluoride, ammonium trifluoride, a higher ammonium polyfluoride, a phosphonium fluoride, a phosphonium hydrogen difluoride, a phosphonium dihydrogen trifluoride and/or a higher phosphonium polyfluoride. Preferred are higher phosphonium polyfluorides, which can be prepared by mixing quaternary ammonium and phosphonium fluorides or hydroxides with appropriate amounts of hydrogen fluoride. The catalysts are optionally pre-dissolved in alcohols or water.

The inventive process is preferably carried out at a temperature of from 20° C. to 120° C., preferably 40-80° C., very preferably 50-70° C.

As has already been explained, the oligomerization catalysts which can be used in accordance with the invention can be prepared by known processes, e.g., as described in EP0962455 and EP2415795.

The oligomerization catalyst may be used in substance, as solution or as suspension.

Preferably the oligomerization catalyst is used in solution. Therefore, the oligomerization catalyst is dissolved in a solvent before the addition to the (cyclo)aliphatic diisocyanate.

When the catalyst is used as a solution, depending on the solubility in the solvent used, a solution having a dilution of generally 90-20%, preferably 90-50%, more preferably 85-55% and most preferably 70-80% by weight catalyst content is established.

In principle, suitable solvents are those in which the catalyst has a good solubility. Preferred solvents are alcohols, toluene, xylene, cyclic ethers, carboxylic esters and ketones or mixtures. Very preferred solvents are alcohols comprising methanol, isopropanol or containing at least 6 carbon atoms, more preferred 2-ethyl hexan-1-ol and 2-propyl heptan-1-ol, or their mixtures.

The oligomerization catalysts used may also be mixtures with other known oligomerization catalysts, and these may be mixed in broad ratios, for example in ratios of from 90:10 to 10:90, preferably from 80:20 to 20:80 and more preferably from 60:40 to 40:60.

To prepare the polyisocyanates containing iminooxadiazinedione groups, the oligomerization catalysts, depending on their catalytic activity, are appropriately used in very small effective amounts which can be determined experimentally in a simple manner.

In general, the oligomerization catalysts are used in the process according to the invention in an amount of from 1 ppm to 1%, preferably from 20 ppm to 500 ppm, very preferably from 50 ppm to 300 ppm, most preferably from 50 ppm to 150 ppm based on the (cyclo)aliphatic diisocyanates.

The process according to the invention is appropriately carried out at a temperature in the range from 20 to 120° C. and reaction times of 10 min to 6 hours, preferably of from 20 min to 3 hours, more preferably of from 20 min to 2 hours. Higher oligomerization temperatures are not preferred, because discoloration of the polyisocyanates containing iminooxadiazinedione groups may occur. The temperature is preferably such that the reactivity of the catalyst is sufficiently high. The temperature is preferably such that the share of iminooxadiazinedione versus standard isocyanurate is not dropping too far. The optimum temperature range is given above.

The oligomerization may be carried out continuously, semicontinuously or batchwise, preferably continuously.

In a batch process, in general, it is unimportant which components are initially charged or added. Usually, the isocyanate to be trimerized is at least partly, preferably fully, initially charged and the at least one catalyst is added slowly and/or in portions, then brought to the desired reaction temperature, and the remainder of the catalyst is added, if appropriate in portions.

An alternative preparation variant proceeds as follows: a batchwise process is performed in a stirred reactor. The mixture of diisocyanate and catalyst is initially charged typically at approx. 40° C. After-wards, the oligomerization is initiated by increasing the temperature of the reaction mixture to from 50 to 120° C., preferably to from 50 to 70° C. Alternatively, the catalyst may also be metered in after the diisocyanate has attained the temperature necessary for the reaction. The oligomerization is generally exothermic. The catalyst is preferably dissolved in a suitable solvent and to use it in this form.

The continuous oligomerization may appropriately be carried out continuously in a reaction coil with continuous, simultaneous metering of diisocyanate and the catalyst at from 40 to 120° C. and within from 30 seconds to 4 hours. A reaction coil having a small diameter leads to the achievement of high flow rates and consequently good mixing. It is also advantageous to heat the diisocyanate/catalyst mixture to from approx. 50 to 60° C. before entry into the reaction coil. For more precise metering and optimal mixing of the catalyst, it is also advantageous to dissolve the catalyst in a suitable solvent. In principle, suitable solvents are those in which the catalyst has a good solubility.

The continuous trimerization may also be carried out in a multiple reactor cascade. The reaction is stopped in the last reactor of the cascade or in e.g., a static mixer.

Typically, the reaction is carried out under a gas or gas mixture which is inert under the reaction conditions, for example those having an oxygen content of below 2%, preferably below 1%, more preferably below 0.5% by volume, most preferably no oxygen. Preference is given to nitrogen, argon, nitrogen-noble gas mixtures; particular preference is given to nitrogen.

Once the desired degree of oligomerization, i.e., NCO content, or degree of reaction (based on the NCO content before the reaction) of the iminooxadiazinedione/(cyclo)aliphatic diisocyanate reaction mixture has been attained, the degree of reaction appropriately being in the range of from 5 to 40% of the NCO groups, preferably from 5 to 30% of the NCO groups, very preferably from 5 to 20% of the NCO groups, and for which typically reaction times of from 0.05 to 4 hours, preferably from 20 min to 2 hours, are required, the oligomerization reaction may be ended, for example, by deactivating the oligomerization catalyst.

Preferably the catalyst poison contains at least one acid having a pKa value below 4.0, preferably below 2.0.

Suitable catalyst poisons are inorganic acids or acid esters, for example hydrogen chloride, phosphorous acid, dialkyl phosphorous acids, preferably bis-2-ethyl-hexyl phosphorous acid and bis-butyl-phosphorous acid, phosphoric acid, carbonyl halides, preferably acetyl chloride or benzoyl chloride, sulfonic acids or esters, preferably methanesulfonic acid, p-toluene sulfonic acid, methyl or ethyl p-toluene sulfonate, p-dodecyl benzyl-toluene-sulfonic acid, m-chloroperbenzoic acid.

More preferably the catalyst poison acid ester containing phosphorus or sulfur, very preferably the catalyst poison is para-toluene sulfonic acid or p-dodecyl benzenesulfonic acid.

The catalyst poisons may, based on the oligomerization catalysts, be used in equivalent or excess amounts, and the smallest effective amount, which can be determined experimentally, is preferred simply for economic reasons. For example, the catalyst poison is used in a ratio to the oligomerization catalyst of 0.7:1-1.5:1 mol/mol and very particularly preferably 0.9:1-1.2:1 mol/mol, most preferably 1:1.

The addition of the catalyst poison depends upon the type of the catalyst poison. For instance, liquid catalyst poisons such as dibutylphosphate or di-2-ethylhexyl-phosphate may be added as a solution in a solvent.

Solid catalyst poisons are preferably added in diluted form as a solution or suspension, preferably as a solution.

Solvents preferably are reactive towards NCO groups.

Preferably alcohols are used as solvents.

The catalyst poisons are provided as a solution containing at least one alcohol comprising at least 6 carbon atoms as solvent.

Preferably the alcohol comprises at least 6 carbon atoms but not more than 18 carbon atoms, more preferably the alcohol comprises at least 8 carbon atoms but not more than 15 carbon atoms.

The alcohol may be a primary, secondary, or tertiary alcohol. Primary alcohols are for example 2-ethyl-1-butanol, 2-ethyl-hexane-1-ol; n-octan-1-ol; nonan-1-ol; 2-n-propyl-n-heptane-1-ol; n-decan-1-ol; iso-decan-1-ol [C9-C11-alcohol mixture (C10 rich; “iso-decanol)]; 2-butyl-octan-1-ol; undecane-1-ol; iso-tridecan-1-ol; 2-hexyl-decanol, dodecan-1-ol, 1-tridecyl alcohol, tetradecan-1-ol, pentadecyl alcohol, hexadecyl alcohol, octadecyl alcohol. Alcohols may as well be mixtures of different molecular composition as of different chain lengths.

Secondary alcohols are for example 3-decanol or 4-decanol.

Preferably the alcohol is a primary alcohol. Preferred alcohols are 2-ethyl hexanol and 2-n-propyl heptan-1-ol, very preferred 2-ethyl-hexan-1-ol.

The alcohol may be monofunctional, difunctional or trifunctional. Difunctional alcohols are for example 2-ethyl-1,3-hexandiol, neopentyl glycol, 1,6-hexanediol, 1,7-heptanediol, 1,8-octanediol, 1,9-nonanediol and 1,10-decanediol; branched aliphatic diols such as 3-methyl[1]1,5-pentanediol, 2-methyl-1,8-octanediol, and 2,2-diethyl-1,3-propanediol; cyclic aliphatic diols such as 1,2-cyclohex[1]anediol, 1,4-cyclohexanediol, 1,2-cyclohexanedimethanol, 1,4-cyclohexanedimethanol, 1,3-cyclobutanediol, 2,2,4,4,-te[1]tramethyl-1,3-cyclobutanediol, hydrogenated bi-sphenol A, isosorbide, isomannide, andisoidide, 2-propyl-1,3-heptandiol, 2,4-diethyloctan-1,3-diol, and cycloaliphatic diols, containing 6 to 20 carbon atoms, preferably bis-(4-hydroxycyclohexan)isopropyliden, tetramethylcyclobutandiol, 1,2-, 1,3- or 1,4-cyclohexandiol, cyclooctandiol, norbornandiol, 2,2-bis(4-hydroxycyclohexyl)propane, 1,1-, 1,2-, 1,3- and 1,4-cyclohexandimethanol.

Preferred example is 2-ethyl-1,3-hexandiol.

Mixtures between primary alcohols and secondary alcohols are possible as well, preferably the mixture of 2-ethyl-hexane-1-ol or 2-n-propyl-n-heptane-1-ol with 2-ethyl-1,3-hexandiol, preferably the first one. Preferably the alcohol is monofunctional.

The alcohol may be linear or branched, preferably the alcohol is branched.

The alcohol may be aliphatic or cycloaliphatic. A cyclic alcohol may be cyclo hexanediol or cy-clohexane dimethanol. Preferably the alcohol is aliphatic.

The alcohols may be alkoxylated, for example, ethoxylated, propoxylated or butoxylated. Preferably the alcohol is not alkoxylated.

Alkoxylated alcohols may be for example triethyleneglycol, dipropyleneglycol, 2-butoxyethanol 2-butoxypropanol, triethyleneglycol monoethylether, diethyleneglycol monopropylether, eth-yleneglycol monopentylether, dipropyleneglycol monoethylether, propyleneglycol monopropylether, propyleneglycol monopentylether, poly-THF as poly THF 250, poly-THF 650, poly-THF 1000, poly-THF 1800, poly-THF 1000 poly-THF 2000, poly-THF 2900, 2,2,4-trimethyl-1,3-pentandiol, 1,4-cyclohexanedimethanol, 1,3-cyclohexanedimethanol, polyethylene glycol, polypropylene glycol, and polytetramethylene glycol.

The alcohol may be saturated or unsaturated. Unsaturated alcohols may be for example cis-9-hexadecenol or cis,cis-9,12-octadecadien-1-ol. Preferably the alcohol is saturated.

The solution may contain further solvents, e.g., further alcohols, toluene, xylene, cyclic ethers, carboxylic esters and ketones or mixtures thereof. However, the solution contains at least 30 wt. %, preferably at least 50 wt. %, most preferably at least 80% of the at least one alcohol comprising at least 6 carbon atoms. In the preferred form, only alcohol is used.

Very preferred alcohols are 2-ethyl hexanol and 2-propyl heptan-1-ol. Most preferred is 2-ethyl hexanol.

The alcohols used may also be mixtures of alcohols.

The catalyst poisons are generally added at ambient temperature but might be preheated to the reaction temperature.

The alcohol or mixture of alcohols is preferably liquid at ambient temperature.

In the alcohol comprising at least 6 carbon atoms, the carbon atoms are preferably not interrupted by one or more heteroatoms.

The polyisocyanates containing iminooxadiazinedione groups which are prepared by the process according to the invention may be freed of any solvent or diluent present and/or preferably of excess, unconverted (cyclo)aliphatic diisocyanates in a manner known per se, for example by thin-film distillation at a temperature of from 100 to 180° C. under vacuum, if appropriate addition-ally while passing through inert stripping gas, or extraction, so that the polyisocyanates containing iminooxadiazinedione groups are obtainable with a content of monomeric diisocyanates of, for example, below 1.0% by weight, preferably below 0.5% by weight, more preferably below 0.3% by weight, even more preferably below 0.2% by weight and in particular not more than 0.1% by weight. The polyisocyanates containing iminooxadiazinedione groups are suitable, for example, for coatings, preparing PU foams, cellular or compact elastomers, casting compositions and adhesives.

Without removal of the excess monomeric diisocyanates, the polyisocyanates containing iminooxadiazinedione groups are suitable, for example, for preparing PU foams, cellular or compact elastomers, casting compositions and adhesives. The monomer-free and monomer-containing polyisocyanates containing iminooxadiazinedione groups may also be modified in a manner known per se by introducing, for example, urethane, allophanate, urea, biuret, isocyanurate and/or carbodiimide groups, and/or the isocyanates may be capped with suitable cap-ping agents.

The process according to the invention can be used to oligomerize any organic diisocyanates having aliphatic, cycloaliphatic, or aliphatic and cycloaliphatic isocyanate groups or mixtures thereof.

Suitable aliphatic diisocyanates have advantageously from 3 to 16 carbon atoms, preferably from 4 to 12 carbon atoms, in the linear or branched alkylene radical, and suitable cycloaliphatic diisocyanates have advantageously from 4 to 18 carbon atoms, preferably from 6 to 15 carbon atoms, in the cycloalkylene radical. Examples include:
1,4-diisocyanatobutane, 2-ethyl-1,4-diisocyanatobutane, 1,5-diisocyanatopentane (PDI), 2-me-thyl-1,5-diisocyanatopentane, 2,2-dimethyl-1,5-diisocyanatopentane, 2-propyl-2-ethyl-1,5-diisocyanatopentane, 2-butyl-2-ethyl-1,5-diisocyanatopentane, 2-alkoxymethylene-1,5-diisocyanatopentane, 3-methyl-, 3-ethyl-1,5-diisocyanatopentane, hexamethylene 1,6-diisocyanate (HDI), 2,4,4- or 2,2,4-tri-methylhexamethylene 1,6-diisocyanate, 1,7-diisocyanatoheptane, 1,8-diisocyanatooctane, 1,10-diisocyanatodecane, 1,12-diisocyanatododecane, 4,4′-diisocyanatodicyclohexylmethane, 2,4′-diisocyanatodicyclohexylmethane, and also mixtures of the diisocyanato dicyclohexyl methane isomers, 1,3-diisocyanatocyclohexane and also isomer mixtures of diisocyanato cyclohexanes and 1-isocyanato-3-isocyanatomethyl-3,5,5-trimethylcyclohexane. The (cyclo)aliphatic diisocyanates used are preferably hexamethylene diisocyanate (HDI), pentamethylene diisocyanate (PDI), 5-isocyanato-1-(isocyanatomethyl)-1,3,3-trimethylcyclohexane (IPDI), 2-methyl pentane 1,5-diisocyanate, 2,4,4-trimethyl-1,8-hexane diisocyanate, 2,2,4-trimethyl-1,6-hexane diisocyanate and 4-isocyanatomethyl-1,8-octane, very preferably hexamethylene 1,6-diisocyanate (HDI) and 1,5-diisocyanatopentane (PDI).

It will be appreciated that the oligomerization catalysts also catalyze the trimerization of aromatic isocyanates but are preferred for (cyclo)aliphatic isocyanates.

The inventive process may be used for the oligomerization of (cyclo)aliphatic diisocyanates prepared by any processes, for example by a phosgene-free process route or one proceeding with the use of phosgene.

The (cyclo)aliphatic diisocyanates which can be used in accordance with the invention may be prepared by any processes, for example by phosgenating the appropriate diamines and thermally dissociating the dicarbamoyl chlorides formed as an intermediate. (Cyclo)aliphatic diisocyanates prepared by phosgene-free processes do not contain any chlorine compounds as by-products and therefore contain, because of the preparation, a fundamentally different by-product spectrum.

It will be appreciated that mixtures of isocyanates which have been prepared by the phosgene process and by phosgene-free processes may also be used.

The (cyclo)aliphatic diisocyanates which can be used in the process according to the invention and are obtainable by a phosgene-free process and especially by thermal dissociation of (cyclo)aliphatic dicarbamic esters are not restricted, and preference is given in particular to selecting diisocyanates obtainable by thermal dissociation of (cyclo)aliphatic dicarbamic esters from the group of hexamethylene 1,6-diisocyanate, 2-butyl-2-ethylpentamethylene 1,5-diisocyanate and 1-isocyanato-3-isocyanatomethyl-3,5,5-trimethylcyclohexane.

Viscosities of the products can be in the range of 400 to 10,000 mPa*s, preferably between 500 and 4,000 mPa*s, very preferred between 500 and 1,000 mPa*s.

NCO number of the products can be in the range 20-25%, preferably between 22.5-24.5% and very preferred between 23 and 24%.

In a preferred embodiment of the invention, isocyanate monomers are used which have a total chlorine content of 800 ppm by weight or less, preferably 400 ppm by weight or less, most preferably 200 ppm by weight or less.

In a preferred embodiment of the invention, isocyanate monomers are used which have a hydrolyzable chlorine content of 100 ppm by weight or less, more preferably 50, 25, respectively 20 ppm by weight or less.

Polyisocyanates containing iminooxadiazinedione groups and prepared by these process variants are suitable preferentially for producing polyurethane coatings, for example textile and leather coatings, for polyurethane dispersions and adhesives, and find use in particular as a polyisocyanate component in one- and two-component polyurethane systems for high-grade, weather-resistant polyurethane coatings. These preferably are high-solids or water borne coatings.

Coating formulations obtained are suitable for coating substrates such as wood, wood veneer, paper, cardboard, paperboard, textile, film, leather, nonwoven, plastics surfaces, glass, ceramic, mineral building materials, such as molded cement blocks and fiber-cement slabs, or metals, which in each case may optionally have been precoated or pretreated.

Coating compositions of this kind are suitable as or in interior or exterior coatings, i.e., in those applications where there is exposure to daylight, preferably of parts of buildings, coatings on (large) vehicles and aircraft, and industrial applications, utility vehicles in agriculture and construction, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, such as in parking levels or in hospitals and in particular in automotive finishes, as OEM and refinish application.

ppm and percentage data used in this document relate, unless stated otherwise, to percentages by weight and ppm by weight.

The examples which follow are intended to illustrate the invention, but not restrict it to these examples.

### EXAMPLES

### Description of Miniplant

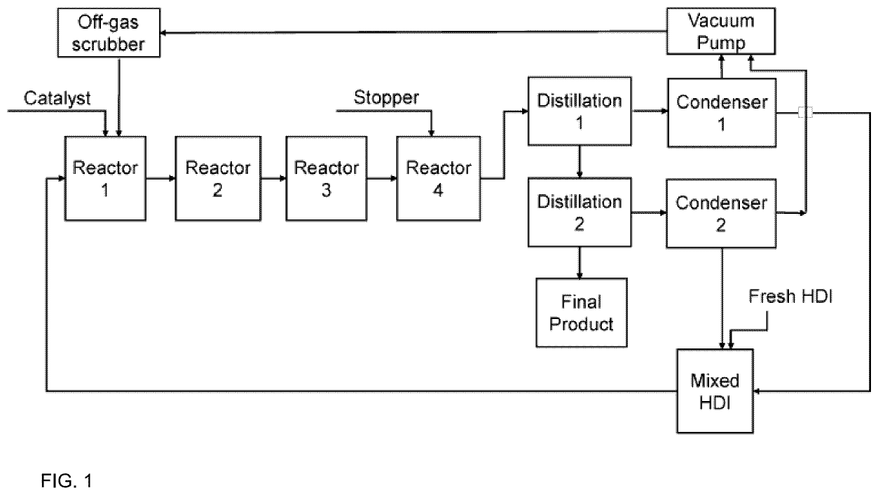

The Miniplant consists of a reactor cascade of four stirred reactors (FIG. 1). They can be heated or cooled with a double walled jacket for heating/cooling oil. Three reactors are used for reaction conversion, the fourth reactor is used for dosing of a chemical stopper.

The reactor cascade is operated with free outflow conditions without additional pumps between the different reactors.

Reaction catalyst is fed into the first reactor.

All reactors are connected to an off-gas system consisting of a washing column with a packed bed. HDI monomer is used as medium for off-gas washing to absorb volatile by-products into the washing medium.

Reactor off-gas leaving the reactor cascade flows through the washing column and leaves the Miniplant into the laboratory off-gas system.

The Miniplant is operated continuously with HDI monomer fed from a drum into the system. The reactor cascade outlet is transferred with a pump in the distillation section. Outflow of the last reactor consists of the target reaction product and unconverted monomer. The monomer needs to be separated before the final product is send to a collection drum.

The distillation section consists of two vacuum evaporation stages. The vacuum is generated with a vacuum pump, the gas discharge of the vacuum pump is also connected to the off-gas washing column.

The vacuum evaporators contain a wiper system which creates a thin film of the product/monomer mixture on the cylindrical wall and a heating jacket, with which the evaporator walls are heated.

The high boiling product stream leaves the evaporators at the bottom outlet and is collected in a product drum.

The light boiler phase which mainly consists of HDI monomer leaves the evaporators over top. Each evaporation stage is connected with an external condenser, which condensates the HDI monomer. The HDI monomer from both condensation stages is collected in a vessel and used as feed flow into the reactor cascade, being mixed with fresh HDI monomer.

The monomer content within the final product can be controlled by adjusting the evaporation conditions as e.g., heating temperature, vacuum pressure, wiper speed in thin film evaporators etc.

Catalyst: Tetrabutyl phosphonium hydrogen difluoride, 72 wt % solution in methanol 19 wt % and isopropanol 9 wt %
Synthesized according to the EP0962455 (example 1)
Water content (measured via Karl-Fischer titration)=0.5 wt %
Stopper solution 1: pTSA hydrate 40% in 2-ethylhexanol
Water content (measured via Karl-Fischer titration)=5 wt %
Stopper solution 2: pTSA hydrate 40% in Isopropanol
Water content (measured via Karl-Fischer titration)=5 wt %
Stopper solution 3: pTSA 40% in Isopropanol
Water content (measured via Karl-Fischer titration)<0.5 wt %
   Details about the Miniplant Parameters:
For all examples, reactor temperature was 60° C. (reactor 1-reactor 2-reactor 3-reactor 4)
Catalyst loading of 120 ppm in the first reactor->Stochiometric amount of pTSA (stopper addition in the fourth reactor)
HDI flow=3000 g/h
Catalyst addition in first reactor with 9.75 microliter/min
First vacuum evaporator: 150° C.
Second vacuum evaporator: 140° C.
Filling of reactors one to three: 1 L which is equivalent to a residence time of 20 min per reactor and a total reaction time of 1 hour 20 min after fourth reactor->1 hour before addition of stopper

### Analytics:

Asymmetric trimer AST and symmetric trimer ST content were measured with 13C-NMR

### Inventive Example: Stopper Solution 1 (in 2-Ethylhexanol)

After 48 hours of running continuously to reach equilibrium which corresponds to a stable NCO content in each reactor: NCO content reached 43.0% in the fourth reactor

### After Distillation:

NCO content: 23.4%
Viscosity: 1080 mPa·s
AST content: 45 mol %
ST content: 50 mol %

### Comparative Example 1: Stopper Solution 2 (in Isopropanol with Water)

After 48 hours of running continuously to reach equilibrium which corresponds to a stable NCO content in each reactor: NCO content reached 44.6% in the fourth reactor

### After Distillation:

NCO content: 23.6%
Viscosity: 960 mPa·s
AST content: 45 mol %
ST content: 50 mol %

### Comparative Example 2: Stopper Solution 3 (in Isopropanol-Water-Poor)

After 48 hours of running continuously to reach equilibrium which corresponds to a stable NCO content in each reactor: NCO content: 44.4% in the fourth reactor

### After Distillation:

NCO content: 23.6%
Viscosity: 980 mPa·s
AST content: 45 mol %
ST content: 50 mol %

### Effect:

When working with 2-ethylhexanol solution higher conversion for the same catalyst amount (visible by lower NCO before stopping, after stopping and higher viscosity).

To achieve lower viscosities of e.g., those of the comparative examples the process would have to be adapted accordingly to e.g., use of less catalyst, shorter hold-up time or lower temperature. Less catalyst is advantageous in respect to reduction of side components and product quality.

Effect of water content in stopper solution when working with isopropanol is almost irrelevant. Reactivity is way more improved by changing the solvent than with working with less water in catalyst solution.

1. A process for the preparation of polyisocyanates containing iminooxadiazinedione groups, comprising reacting at least one (cyclo)aliphatic diisocyanate in the presence of at least one oligomerization catalyst, and when the reaction has reached a predeterminable degree of conversion, based on the (cyclo)aliphatic diisocyanates, stopping the reaction by addition of at least one catalyst poison for the oligomerization catalyst, wherein the oligomerization catalyst is a salt containing a fluoride or poly(hydrogen)fluoride [F⁻×(HF)ₘ] as anion and the catalyst poison is a solution containing at least one alcohol comprising at least 6 carbon atoms as solvent and wherein m is a number between 0.01 and 20.

2. The process according to claim 1, wherein the alcohol has between 6 and 18 carbon atoms.

3. The process according to claim 1 or 2, wherein the alcohol is a primary alcohol.

4. The process according to any of the proceeding claims, wherein the alcohol is branched.

5. The process according to any of the proceeding claims, wherein the alcohol is monofunctional.

6. The process according to any of the proceeding claims, wherein the alcohol is saturated.

7. The process according to any of the proceeding claims, wherein the alcohol is selected from the group consisting of 2-ethyl hexanol and 2-propyl heptan-1-ol.

8. The process according to any of the proceeding claims, wherein the solution contains at least 30 wt. %, preferably at least 50 wt. %, of the at least one alcohol comprising at least 6 carbon atoms.

9. The process according to any of the proceeding claims, wherein the catalyst poison contains at least one acid having a pKa value below 4.0, preferably below 2.0.

10. The process according to claim 9, wherein the acid is an acid ester containing phosphorous or sulfur.

11. The process according to claim 9, wherein the acid is a sulfonic acid derivative more preferable, paratoluene sulfonic acid or dodecyl benzene-sulfonic acid.

12. The process according to any of the proceeding claims, wherein the catalyst poison is used in a ratio to the oligomerization catalyst of 0.7:1-1.5:1 mol/mol and very particularly preferably 0.9:1-1.2:1 mol/mol

13. The process according to any of the proceeding claims, wherein the (cyclo)aliphatic diisocyanates are selected from the group consisting of hexamethylene diisocyanate (HDI), pentamethylene diisocyanate (PDI), 5-isocyanato-1-(isocyanatomethyl)-1,3,3-trimethylcyclohexane (IPDI), 2-methyl pentane 1,5-diisocyanate, 2,4,4-trimethyl-1,8-hexane diisocyanate, 2,2,4-trimethyl-1,6-hexane diisocyanate and 4-isocyanatomethyl-1,8-octane.

14. The process according to any of the proceeding claims, wherein the degree of conversion is 5 to 40% of the NCO groups of the (cyclo)aliphatic diisocyanates.

15. The process according to any of the proceeding claims, wherein the reaction is carried out at a temperature of from 20° C. to 120° C., preferably from 50° C. to 70° C.

16. The process according to any of the proceeding claims, wherein the amount of the trimerization catalyst is from 20 ppm to 500 ppm, based on the (cyclo)aliphatic diisocyanate.

17. The process according to any of the proceeding claims, comprising dissolving the trimerization catalyst in a solvent before the addition to the (cyclo)aliphatic diisocyanate.

18. The process according to any of the proceeding claims, comprising separating off unreacted (cyclo)aliphatic diisocyanate after the degree of conversion has been reached.

19. A polyisocyanate obtained according to any of the proceeding claims, wherein the polyisocyanate has a viscosity between 400 and 10,000 mPa*s, preferably between 500 and 4,000 mPa*s, very preferably between 500 and 1,000 mPa*s.

20. The use of a polyisocyanate obtained according to any of the proceeding claims as a curing agent in a coating composition, in primers, surfacers, pigmented topcoat, basecoat, and clearcoat materials in the segment of refinish, in automotive refinish, large-vehicle coating, and wood coating, and also as a curing agent in coating materials, adhesives, and sealants.

1.-20. (canceled)

21. A process for the preparation of polyisocyanates containing iminooxadiazinedione groups, comprising reacting at least one (cyclo)aliphatic diisocyanate in the presence of at least one oligomerization catalyst, and when the reaction has reached a predeterminable degree of conversion, based on the (cyclo)aliphatic diisocyanates, stopping the reaction by addition of at least one catalyst poison for the oligomerization catalyst, wherein the oligomerization catalyst is a salt containing a fluoride or poly(hydrogen)fluoride [F⁻×(HF)ₘ] as anion and the catalyst poison is a solution containing at least one alcohol comprising at least 6 carbon atoms as solvent and wherein m is a number between 0.01 and 20.

22. The process according to claim 21, wherein the alcohol has between 6 and 18 carbon atoms.

23. The process according to claim 21, wherein the alcohol is a primary alcohol.

24. The process according to claim 21, wherein the alcohol is branched.

25. The process according to claim 21, wherein the alcohol is monofunctional.

26. The process according to claim 21, wherein the alcohol is saturated.

27. The process according to claim 21, wherein the alcohol is selected from the group consisting of 2-ethyl hexanol and 2-propyl heptan-1-ol.

28. The process according to claim 21, wherein the solution contains at least 30 wt. % of the at least one alcohol comprising at least 6 carbon atoms.

29. The process according to claim 21, wherein the catalyst poison contains at least one acid having a pKa value below 4.0.

30. The process according to claim 29, wherein the acid is an acid ester containing phosphorous or sulfur.

31. The process according to claim 29, wherein the acid is a sulfonic acid derivative.

32. The process according to claim 21, wherein the catalyst poison is used in a ratio to the oligomerization catalyst of 0.7:1-1.5:1 mol/mol.

33. The process according to claim 21, wherein the (cyclo)aliphatic diisocyanates are selected from the group consisting of hexamethylene diisocyanate (HDI), pentamethylene diisocyanate (PDI), 5-isocyanato-1-(isocyanatomethyl)-1,3,3-trimethylcyclohexane (IPDI), 2-methyl pentane 1,5-diisocyanate, 2,4,4-trimethyl-1,8-hexane diisocyanate, 2,2,4-trimethyl-1,6-hexane diisocyanate and 4-isocyanatomethyl-1,8-octane.

34. The process according to claim 21, wherein the degree of conversion is 5 to 40% of the NCO groups of the (cyclo)aliphatic diisocyanates.

35. The process according to claim 21, wherein the reaction is carried out at a temperature of from 20° C. to 120° C.

36. The process according to claim 21, wherein the amount of the trimerization catalyst is from 20 ppm to 500 ppm, based on the (cyclo)aliphatic diisocyanate.

37. The process according to claim 21, comprising dissolving the trimerization catalyst in a solvent before the addition to the (cyclo)aliphatic diisocyanate.

38. The process according to claim 21, comprising separating off unreacted (cyclo)aliphatic diisocyanate after the degree of conversion has been reached.

39. A polyisocyanate obtained according to claim 21, wherein the polyisocyanate has a viscosity between 400 and 10,000 mPa*s.

40. The use of a polyisocyanate obtained according to claim 21 as a curing agent in a coating composition, in primers, surfacers, pigmented topcoat, basecoat, and clearcoat materials in the segment of refinish, in automotive refinish, large-vehicle coating, and wood coating, and also as a curing agent in coating materials, adhesives, and sealants.
